(19) United States
(12) Patent Application Publication
(10) Pub. No.: US 2005/0209757 A1
(43) Pub. Date: Sep. 22, 2005

(54) Method for releasing a safety device in a motor vehicle in the event of an overturn

(76) Inventors: Hermann Kueblbeck, Schrobenhausen (DE); Markus Larice, Ingolstadt (DE); Helmut Steurer, Gerolsbach-Junkenhofen (DE)

Correspondence Address: FASSE PATENT ATTORNEYS, P.A., P.O. BOX 726, HAMPDEN, ME, 04444-0726, US

(21) Appl. No.: 10/513,073

(22) PCT Filed: May 2, 2003
(86) PCT No.: PCT/EP03/04607

§ 371 Date: Oct. 29, 2004

(51) Int. Cl. G05D 1/00

(52) U.S. Cl. 701/46

(57) ABSTRACT

Method for the triggering of a safety device in a motor vehicle in a rollover process, wherein the rotation rate signals ω generated by a rotation rate sensor are evaluated for the recognition of the rollover process of the motor vehicle about one of its axes. In that regard, predominantly roll bars, side airbags, and belt tensioners come into consideration as safety devices. The object of the invention consists in presenting a method for the triggering of a safety device, without, however, simultaneously suffering an impairment of the safe and reliable recognizing of a tip-over. According to the invention, low-pass filtered rotation rate signals are compared with an adjustable threshold value, whereby this threshold value is generated dependent on the integrated rotation rate signal. In that regard, the low-pass filtering occurs with a limit frequency, with which the signal components of the rotation rate signal characteristic for a rollover process remain unfiltered.

The invention relates to a method for the triggering of a safety device in a motor vehicle in a rollover process, in which the rotation rate signals produced by a rotation rate sensor are evaluated for the recognition of a tip-over of the motor vehicle about one of its axes. In that regard, predominantly roll bars, side airbags, and belt tensioners come into consideration as safety devices.

For the recognition of a tip-over of a motor vehicle, for example with respect to its longitudinal axis (x-axis), it is known for this purpose to evaluate the rotation rate signals produced by a rotation rate sensor (gyro sensor). A corresponding evaluating method is, for example, known from the DE 100 25 259 A1, in which the method begins and proceeds from a theoretical tip-over characteristic curve in the form of a ω-α-graph adapted to the respective vehicle. This ω-α-graph is approximated through low-pass filter functions with certain limit frequencies and trigger thresholds respectively adapted to the tip-over scenarios that are to be detected. The rotation rate signals are processed and evaluated by these low-pass filter functions, in order to bring about a triggering of a safety device if applicable. It is disadvantageous in this known method, however, that voluminous data material must be available for the developing and for the adaptation of this triggering algorithm to a special vehicle type.

A different method for the detection of rollover processes is known from the DE 100 25 260 A1, in which, for the calculation of the current actual tilt angle of the vehicle, the value of the integrated rotation rate signal is added to the initial or starting tilt angle of the vehicle produced by an inertial position (or attitude) sensor, and this calculated current actual tilt angle is compared with a threshold value, whereby this threshold value is produced dependent on the rotation rate signal and in a form adapted to the respective vehicle type. In a disadvantageous manner, this method requires the use of a tilt sensor for the determination of the initial or starting tilt of the vehicle.

Further ones of such evaluating methods are known from the DE 199 05 193 and DE 199 05 379, which provide the evaluation of the rotation rate signals through two independent channels, namely on the one hand through evaluation of the differentiated rotation rate signals and through evaluation of the integrated rotation rate signals on the other hand. In the latter named evaluation, the integrated rotation rate signals are compared with a threshold value produced dependent on the rotation rate.

Whether a value pair, consisting of an integrated rotation rate signal and the associated rotation rate, is evaluated as a vehicle condition leading to a tip-over, is determined or decided in connection with a prescribed vehicle-specific tip-over characteristic curve, which devices the arising value pairs into no-fire areas or regions (no triggering of a safety device) and fire areas or regions (triggering of a safety device).

The methods described in DE 196 09 717 A1 and DE 197 44 083 A1 derive the corresponding Cardanic angles from the rotation rates measured in all three axes of a vehicle, through integration, in order to determine therefrom the position of a vehicle's center of gravity projected into a horizontal plane and to signal a rollover of the vehicle if the projected center of gravity exceeds the boundaries or limits of a vehicle-fixed surface similarly projected into the horizontal plane. Furthermore, in this known method, the rotation energy of the vehicle is derived from the rotation rates, in order to recognize a tip-over then when the rotation energy exceeds a certain threshold, which may, for example, be that potential energy that is required for tilting or tipping the vehicle out of its momentary position (or attitude) into a position (or attitude) in which the center of gravity reaches its maximum spacing distance relative to the roadway (or driving surface) plane.

The object of the invention consists in presenting a method for the triggering of a safety device, which requires little data material for the realization, and with which simultaneously tip-overs are timely and reliably recognizable.

This object is achieved by the characterizing features of the patent claim 1. According to this, the rotation rate signals produced by a rotation rate sensor with respect to a rotation axis are both low-pass filtered by means of a low-pass filter, with a limit frequency at which the signal components of the rotation rate signal characteristic for a rollover process pass this low-pass filter un-filtered, as well as for the production or generation of an integral value dependent on the rotation rate of the vehicle, whereby a trigger signal for the triggering of a safety device is then produced when the low-pass filtered rotation rate signal exceeds an adjustable trigger threshold value that is produced dependent on the integral value. Preferably, the limit frequency of the utilized low-pass filter is selected in such a manner that rapid tip-overs are recognized timely and safely or surely. In that regard, the limit frequency lies at a few Hz. This is achieved in an advantageous manner in that, through corresponding adjustment of the limit frequency of the utilized low-pass filter and the adjustment of the trigger threshold value dependent on the integrated rotation rate signal, a tip-over characteristic curve adapted to the vehicle is realizable in such a manner that the value pairs coming into consideration for the low-pass filtered and the integrated rotation rate signals are nearly unambiguously classifiable into no-fire regions and fire regions.

According to an advantageous further embodiment of the invention, besides the rotation rate of the vehicle, further vehicle condition-specific parameters indicating the stability, especially the vertical acceleration, lateral acceleration, or the tilting of the vehicle, are detected by means of sensors, and the value of the trigger threshold value is adapted, depending on at least one of these parameters, to the stability condition of the vehicle indicated by this parameter. If, for example, the transverse or lateral acceleration is used as a parameter, then the triggering shall occur earlier in connection with a high acceleration value than for lower lateral or transverse acceleration of the vehicle, which, with respect to the tip-over characteristic curve, means a shifting of the characteristic line or curve separating the no-fire region from the fire region. The method thereby becomes more sensitive with respect to the lateral or transverse acceleration. If, contrary thereto, the vertical acceleration of the vehicle is to be used as a parameter, then the tip-over characteristic curve is similarly to be shifted to smaller values if the acceleration value significantly deviates from the value 1G, i.e. indicates a condition that tends toward weightlessness.

A further advantageous embodiment of the invention consists in providing a further low-pass filter for the filtering of the rotation rate signal, whereby its limit frequency is adjusted in such a manner so that the signal components of the rotation rate signal that are characteristic for a slow rollover process pass this further low-pass filter unfiltered, and thereafter only then are compared with a fixed trigger threshold value when the integrated rotation rate signal reaches a fixed angle threshold value. Because this integrated rotation rate signal approximately corresponds to the tilt angle of the vehicle, this angle threshold value represents a minimum tilt angle. Only once this minimum tilt angle is reached, a comparison of the filtered rotation rate signal with the fixed threshold value occurs, which fixed threshold value preferably represents a minimum rotation rate. Thereby a triggering of a safety device is also ensured for slow tip-overs—at the latest when the vehicle is lying on its side.

For the improvement of the triggering safety or security in all arising tip-over scenarios, a third low-pass filtering of the rotation rate signal can be carried out, whereby the limit frequency of the utilized low-pass filter lies between the value of the limit frequency of the first low-pass filter and the value of the limit frequency of the second low-pass filter.

For the further improvement of the triggering safety or security, according to an especially advantageous embodiment of the invention, the sensor signals of the further sensors indicating the stability of the vehicle can be utilized for the plausibilization, so that a triggering is only made possible if all sensor signals actually allow an imminent tip-over to be recognized. Thus, preferably, the lateral acceleration of the vehicle, after a low-pass filtering, can be compared with a plausibility threshold, whereby a triggering is only permitted if the value of this lateral acceleration comprises a minimum value, whereby especially roll-over processes in the sand bed or with a curb impact are detected.

Also the vertical acceleration of the vehicle can be utilized for the plausibilization, in that the trigger threshold value is adjusted so that a triggering only occurs if the vertical acceleration significantly deviates from the value 1G. Thereby, especially rollover processes of the screw or spiral ramp type or tip-overs over a cliff are detected, in which the vertical acceleration indicates weightlessness.

In the following, the inventive method shall be explained on the basis of example embodiments in connection with the drawings. It is shown by:

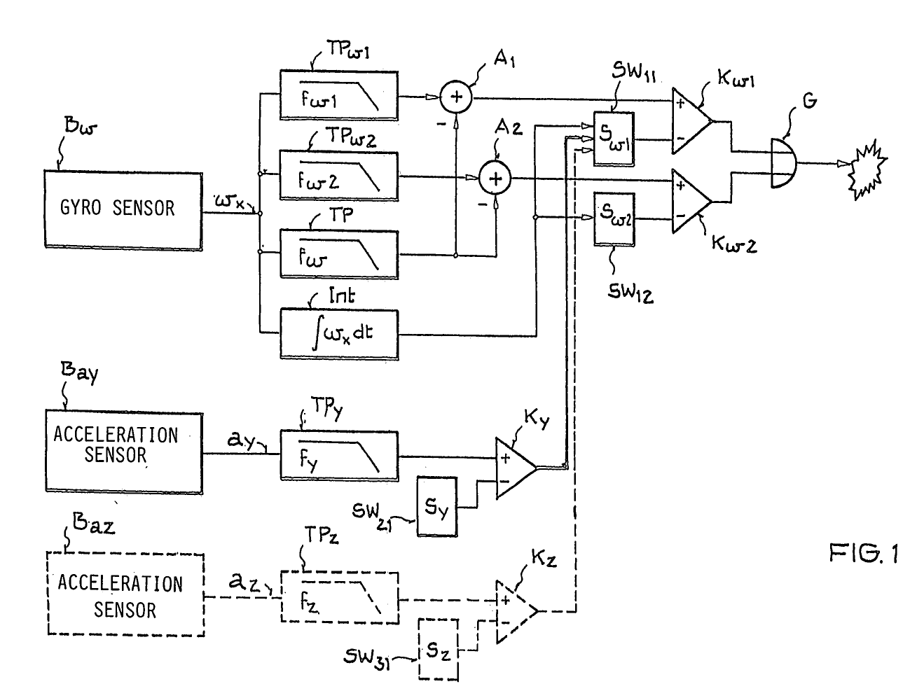

FIG. 1 a block circuit diagram for the carrying out of the inventive method,

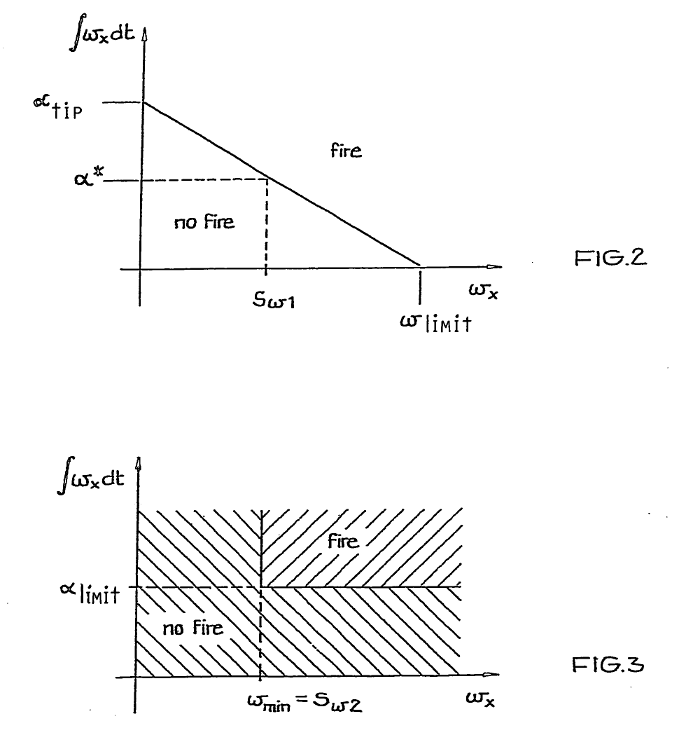

FIG. 2 a tip-over characteristic curve in the representation of an ωₓ-∫ωₓdt-diagram for the explanation of the manner of operation or functioning of the arrangement according to FIG. 1,

FIG. 3 a further tip-over characteristic curve for the explanation of the manner of operation or functioning of the arrangement according to FIG. 1, and

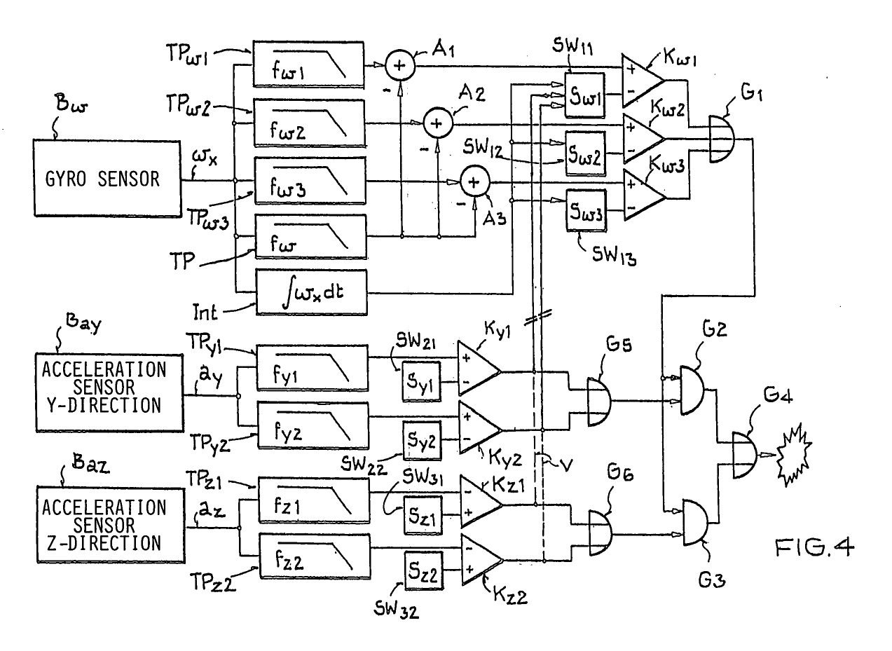

FIG. 4 a block circuit diagram of a further example embodiment for the carrying out of the inventive method.

In the figures, the same functional blocks or similarly operating parts are provided with the same reference characters. In that regard, the block circuit diagrams are to be understood in such a manner that the illustrated functional blocks are realizable both with analog components as well as in a software manner, with respect to their function, by means of a processor. In the latter named case, the analog sensor signals are digitalized before their processing, and are provided to digital filters, generally of first order, for the processing.

The block circuit diagram according to FIG. 1 shows a safety system with an arrangement for the carrying out of the inventive method. This arrangement consists initially of a rotation rate or gyro sensor B_{ω}, which generates or produces a rotation rate signal proportional to the angular velocity ωₓ (rotation rate) about the lengthwise or longitudinal axis (x-axis) of a vehicle. The rotation rate signal is provided or delivered to three low-pass filters TP_{ω1}, TP_{ω2}, and TP, as well as an integrator Int for the purpose of integration of the rotation rate signal ωₓ.

Before the low-pass filtered rotation rate signals present at the output of the low-pass filters TP_{ω1} and TP_{ω2} are subjected to a threshold value comparison with respectively one comparator K_{ω1} or K_{ω2}, an offset- and offset-drift correction occurs, in that the rotation rate signals filtered by the low-pass TP are subtracted by means of adders A1 and A2 from the output signals of the low-pass filters TP_{ω1} and TP_{ω2}. The low-pass filter TP utilized for the offset- and offset-drift correction is of first order with a limit frequency f_{ω} of approximately 10 mHz.

The respective low-pass filtered and offset corrected rotation rate signal are provided to the already mentioned comparators K_{ω1} and K_{ω2} via their non-inverting inputs, while a threshold value generation circuit SW₁₁ or SW₁₂ is respectively connected to the inverting inputs thereof. For the generation of a corresponding trigger threshold value, the integrated rotation rate signal ∫ωₓdt generated by the integrator Int are provided to these threshold value generation circuits SW₁₁ and SW₁₂.

The limit frequency f_{ω1} of the low-pass filter TP_{ω1} is selected so that the signal components of the rotation rate signal ωₓ characteristic for a rapid tip-over pass this low-pass filter unfiltered. The order of magnitude of this limit frequency in that context lies at a few Hz.

The integral value ∫ωₓdt generated or produced by the integrator Int serves the threshold value generation circuit SW₁₁ for the establishment of a trigger threshold value S_{ω1}, which exists or is applied on the inverting input of the comparator K_{ω1}. A vehicle-specific tip-over characteristic curve, as this is illustrated, for example, with an ωₓ-∫ωₓdt diagram according to FIG. 2, serves for the determination of this trigger threshold value S_{ω1} dependent on the integral value ∫ωₓdt. In that regard, ωₓ represents the amount or value of the rotation rate, i.e. the rotation speed of the rolling motion that arises in connection with a threatening or impending tip-over of the vehicle with respect to its x-axis, and ∫ωₓdt represents the value of the integrated rotation rate signal, which corresponds essentially to the tilt angle of the vehicle in the y-direction (transverse or crosswise axis). The ωₓ-∫ωₓdt graph of this diagram, which, contrary to the straight lines illustrated in FIG. 2, can be realized as a multi-stage step function, divides the (ωₓ, ∫ωₓdt) value pairs of the first quadrant into two regions, which on the one hand relate to driving conditions that shall lead to the triggering of a safety device, i.e. fire scenarios, and on the other hand represent no-fire scenarios of which the (ωₓ, ∫ωₓdt) combinations are not allowed to lead to triggering of the safety device. The (ωₗᵢₘᵢₜ, 0) combination or (0, αₜᵢₚ) combination represents a boundary or limit condition of a vehicle with a rotation rate ωₗᵢₘᵢₜ in the x-direction and a tilt angle of 0° or with a rotation a rotation rate 0 and a tilt angle (static tip angle) αₜᵢₚ, which leads to a tip-over. These parameters are vehicle-specific and must therefore be determined separately for each vehicle type.

For a certain or particular Veldt value produced by the integrator Int, designated as α^{*} in FIG. 2, the associated ωₓ value is determined by means of the ωₓ-∫ωₓdt graph according to FIG. 2, which ωₓ value is provided as the trigger threshold value S_{ω1} to the comparator K_{ω1}. If the value produced by the low-pass filter TP_{ω1} exceeds this trigger threshold value S_{ω1}, then a trigger signal is output via an OR-gate G to a safety device.

In contrast, the trigger threshold value S_{ω2} output from the threshold value generation circuit SW₁₂ to the comparator K_{ω2} is prescribed as a fixed value and arises from the ωₓ-∫ωₓdt diagram according to FIG. 3. According to this, a triggering shall occur after reaching of a minimum rotation rate ωₘᵢₙ an of the vehicle only if a certain ∫ωₓdt value is produced, i.e. the vehicle comprises a certain minimum tilt angle αₗᵢₘᵢₜ. In that regard, the minimum rotation rate ωₘᵢₙ is dependent on the frequency content of the rotation rate signal, and therewith on the limit frequency of the utilized low-pass filter TP_{ω2}. In that regard, the allot value is adjusted so that a triggering of the safety device occurs for slow tip-over processes at the latest when the vehicle is lying on its side, while a triggering is omitted upon driving into a steep wall which generally does not comprise 90°.

Besides the gyro sensor B_{ω}, the arrangement according to FIG. 1 comprises a further sensor B_{ay} that detects the lateral or transverse acceleration of the vehicle. The acceleration signal a_{y} of the further sensor B_{ay} is first provided to a low-pass filter TP_{y}, of which the limit frequency f_{y} is adjusted in such a manner in order to provide the signal components characteristic for a transverse acceleration unfiltered to the non-inverting input of a comparator K_{y} for the purpose of comparison with a threshold value S_{y}, whereby the output of this comparator K_{y} is connected with the threshold value generation circuit SW₁₁. The threshold value S_{y} is output from a threshold value generation circuit SW₂₁ to the inverting input of the comparator K_{y} and corresponds to a certain value or magnitude of the transverse acceleration. If this threshold value S_{y} is exceeded by the filtered acceleration signal, the level change that is triggered thereby causes the tip-over characteristic curve according to FIG. 2 that is used for the outputting of the trigger threshold value S_{ω1} to be shifted toward smaller values. Thereby the arrangement becomes more sensitive with respect to high transverse accelerations of the vehicle, and a shorter reaction time from the time point of the detection of an impending tip-over until the triggering of the safety device is ensured.

Instead of the acceleration sensor B_{ay} measuring the transverse acceleration, an acceleration sensor B_{az} measuring the vertical acceleration of the vehicle can also be used, of which the signals are similarly filtered by means of a low-pass filter TP_{z} and are compared, by means of a comparator K_{z}, with a threshold value S_{z} generated by a threshold value generation circuit SW₃₁, whereby, upon the exceeding of this threshold value by the filtered acceleration signal, the corresponding level change similarly is provided to the threshold value generation circuit SW₁₁. The FIG. 1 shows these components B_{az}, TP_{z}, K_{z} and SW₃₁ as well as the connection lines in a dashed line illustration.

Through a level change effectuated by the comparator K_{z}, the threshold value generation circuit SW₁₁, is similarly caused to output trigger threshold values S_{ω1} shifted to smaller values. For the determination of the threshold value S_{Z} to be output by the threshold value generation circuit SW₃₁, one proceeds from the consideration that a stable vehicle condition is present if the value of the acceleration signal output by the acceleration sensor B_{az} amounts to at least 1G (=earth's gravitational acceleration). In such a condition, no adaptation of the trigger threshold value S_{ω1} is necessary. Contrary thereto, for low a_{z} values, one must proceed from a less-stable driving condition of the vehicle, with the result that now an adaptation of the trigger threshold value S_{ω1} must be carried out in such a manner that with corresponding ω₁ values a triggering must occur earlier than for a stable vehicle position (or attitude). These considerations must be taken into account in the setting or specifying of the thresholds S_{z} for the threshold value generation circuit SW₃₁.

In the arrangement according to FIG. 1 for the carrying out of the inventive method, naturally the acceleration sensor B_{y} for the detection of the transverse acceleration a_{y} as well as the acceleration sensor B_{z} for the detection of the vertical acceleration can be simultaneously utilized, in order to ensure an optimum dynamic adaptation of the trigger threshold S_{ω1}. In this case, the outputs of the two comparators K_{y} and K_{z} are separately connected via a separate line respectively with the threshold value generation circuit SW₁₁ (illustrated in the FIG. 1 by two parallel dashed-represented lines).

The arrangement according to FIG. 4 differs relative to that according to FIG. 1 initially by the number of the low-pass filters provided for the evaluation of the rotation rate ωₓ output by the rotation rate sensor B_{ω}, and of the corresponding following or downstream-connected comparators with associated threshold value generation circuits. Besides the low-pass filter TP_{ω1}, further low-pass filters TP_{ω2} and TP_{ω3} are utilized, whereby the low-pass filter TP_{ω2} corresponds to the low-pass filter TP_{ω2} of FIG. 1 with respect to its function and layout or design, i.e. is provided for the detection of slow tip-overs. Respectively one comparator K_{ω1}, K_{ω2} and K_{ω3} with associated threshold value generation circuits SW₁₁, SW₁₂ and SW₁₃ is circuit-connected after each one of the three low-pass filters TP_{ω1}, TP_{ω2} and TP_{ω3} whereby these threshold value generation circuits respectively output a trigger threshold value SW_{ω1}, SW_{ω2} or SW_{ω3}. The outputs of the three comparators K_{ω1}, K_{ω2} and K_{ω3} are similarly guided or lead to an OR-gate G₁, which in turn actuates an AND-gate G₂ and an AND-gate G₃ with respectively two inputs. The signals output by the low-pass filters TP_{ω1}, TP_{ω2} and TP_{ω3} are subjected to an offset- and offset-drift correction similarly as shown in FIG. 1, in that the signal output by the low-pass filter TP is subtracted from these by means of adders A₁ to A₃.

As already described above, the limit frequency f_{ω2} as well as the trigger threshold value S_{ω2} output by the threshold value generation circuit SW₁₂ is adjusted as for the low-pass filter TP_{ω2} or the threshold value generation circuit SW₁₂ according to FIG. 1. Now, the limit frequency f_{ω3} of the additional low-pass filter TP_{ω3} is adjusted so that the value thereof lies between the value of the limit frequency f_{ω1} of the first low-pass filter TP_{ω1} and the value of the limit frequency f_{ω3} of the second low-pass filter TP_{ω2}. The controlling or determinative threshold values αₗᵢₘᵢₜ and ωₘᵢₙ (as trigger threshold value S_{ω3}) that are to be adjusted by the threshold value generation circuit SW₁₃ similarly lie somewhat lower than the values utilized in the arrangement according to FIG. 1.

In a corresponding manner, also for the evaluation of the acceleration signals of the acceleration sensor B_{ay} for the transverse direction and of the acceleration sensor B_{az} for the vertical direction, respectively not only one single low-pass filter, but rather respectively two low-pass filters TP_{y1} and TP_{y2} or respectively TP_{z1} and TP_{z2} are utilized. Also respectively one comparator K_{y1} and K_{y2} or respectively K_{z1} and K_{z2} with associated threshold value generation circuits SW₂₁ and SW₂₂ or respectively SW₃₁ and SW₃₂ are circuit-connected after these low-pass filters, whereby the mentioned threshold value generation circuits output threshold values S_{y1} and S_{y2} or respectively S_{z1} and S_{z2}.

The outputs of the comparators K_{y1} and K_{y2} are provided via separate lines to respectively one input of the threshold value generation circuit SW_{ω1}, so that a dynamic threshold value adaptation can be carried out as in the arrangement according to FIG. 1, whereby with acceleration values indicating unstable driving conditions of the vehicle lead to the reduction of the trigger threshold values S_{ω1}, thus triggering is effectuated already at small ωₓ values.

The limit frequencies f_{y1} and f_{y2} of the low-pass filters TP_{y1} and TP_{y2} are adjusted so that the first low-pass filter TP_{y1} comprises a high limit frequency f_{y1} and the second low-pass filter TP_{y2} comprises a low limit frequency f_{y2}. The same applies to the threshold values S_{y1} and S_{y2} produced by the threshold value generation circuits SW₂₁ and SW₂₂.

For the plausibilization of the rotation rate signals ωₓ possibly leading to the triggering, the outputs of the comparators K_{y1} and K_{y2} are additionally provided via an OR-gate G₅ to the second input of the AND-gate G₂, so that a triggering is permitted only when the transverse acceleration comprises a minimum value |y| through corresponding adjustment of the threshold values S_{y1} and S_{y2}, whereby especially rollover processes in the sand bed or rollover processes caused by a curb impact are detected.

Thus, a triggering via a further OR-gate G₄ occurs only when both the OR-gate G₁ transmits or conducts-further a trigger signal as well as at least one of the comparators K_{y1} or K_{y2} produces a high level.

The evaluated acceleration signals of the acceleration sensor B_{az} similarly serve for the plausibilization of the rotation rate signals ωₓ possibly leading to the triggering, in that the outputs of the comparators K_{z1} and K_{z2} are provided via an OR-gate G₆ to the one input of the AND-gate G₃, and the second input thereof is connected with the output of the OR-gate G₁. For the fulfillment of this purpose, the limit frequencies f_{z1} and f_{z2} of the low-pass filters TP_{z1} and TP_{z2} as well as the threshold values S_{z1} and S_{z2} to be prepared by the threshold value generation circuits SW₃₁ and SW₃₂ are adjusted so that a triggering is only permitted when the acceleration in vertical direction significantly deviates from the value 1G (=earth's gravitational acceleration), whereby especially rollover processes of the screw or spiral ramp type (a_{z} greater than 1G), for which a triggering shall occur already in the upward movement, or a tip-over over a cliff, in which the a_{z} value indicates approximately weightlessness, are detected.

Also the limit frequencies f_{z1} and f_{z2} of the low-pass filters TP_{z1} and TP_{z2} are adjusted so that the first low-pass filter TP_{z1} comprises a high limit frequency f_{z1} and the second low-pass filter TP_{z2} comprises a low limit frequency f_{z2}. The same applies to the threshold values S_{z1} and S_{z2} generated by the threshold value generation circuits SW₃₁ and SW₃₂.

Finally, the evaluated acceleration signals a_{z} of the acceleration sensor B_{az}—as is also realizable in the arrangement according to FIG. 1—can be used for the dynamic adaptation of the trigger threshold values S_{ω1}, in that the outputs of the comparators K_{z1} and K_{z1} are provided via separate lines to separate inputs of the threshold value generation circuit SW_{ω1}, as this is shown in FIG. 4 with dashed connecting lines V. Thereby the trigger threshold value S_{ω1} is adjusted dependent on the output values of the comparators K_{y1}, K_{y2}, K_{z1} and K_{z2}.

Moreover, it should be mentioned that the number of the utilized low-pass filters for the evaluation of the acceleration signals does not need to remain limited to two. If, for example, respectively a third low-pass filter is used for the evaluation of the acceleration signals a_{y} and a_{z}, then the limit frequencies thereof are adjusted in such a manner so that the first low-pass filter comprises the highest limit frequency and the third low-pass filter comprises the lowest limit frequency in a diminishing succession. The same applies to the threshold values.

1. Method for the triggering of a safety device in a motor vehicle in a rollover process by means of a rotation rate sensor (B_{ω}), in which the rotation rate signals (ωₓ) generated by the rotation rate sensor (B_{ω}) are evaluated for the recognition of the rollover process, and the following method steps are carried out:
a) low-pass filtering of the rotation rate signals (ωₓ) by means of a low-pass filter (TP_{ω1}) with a limit frequency (f_{ω1}), in which the signal components of the rotation rate signal (ωₓ) characteristic for a rollover process pass this low-pass filter (TP_{ω1}) unfiltered and thereafter are provided to a threshold value comparison with an adjustable trigger threshold value (S_{ω1})
b) integration of the rotation rate signals (ωₓ) for the generation of an integral value (∫ωₓdt) dependent on the rotation rate of the motor vehicle,
c) generation of the trigger threshold value (S_{ω1}) dependent on the integral value (∫ωₓdt), and
d) generation of a trigger signal for the triggering of the safety device upon exceeding of the trigger threshold value (S_{ω1}) by the low-pass filtered rotation rate signal.

2. Method according to claim 1, wherein, besides the rotation rate signals (ωₓ) of the rotation rate sensor (B_{ω}), signals (a_{y}, a_{z}) of further sensors (B_{y}, B_{z}) are processed, whereby the further sensors (B_{y}, B_{z}) detect driving-condition specific parameters indicating the stability of the motor vehicle, especially vertical acceleration (a_{z}), lateral acceleration (a_{y}) and tilt angle (α), and the value of the trigger threshold value (S_{ω1}) is adapted dependent on at least one of these parameters, in that the trigger threshold value (S_{ω1}) is increased or decreased corresponding to the degree of the stability of the motor vehicle indicated by the signals of the further sensors (B_{y}, B_{z}).

3. Method according to claim 2, wherein the lateral acceleration of the motor vehicle is detected by means of an acceleration sensor (B_{y}).

4. Method according to claim 2, wherein the vertical acceleration of the motor vehicle is detected by means of an acceleration sensor (B_{z}).

5-10. (canceled)

11. Method according to claim 1, wherein
a) a second low-pass filtering of the rotation rate signals (ωₓ) is carried out by means of a second low-pass filter (TP₂) with a limit frequency (f_{ω2}), wherein the signal components of the rotation rate signal (ω_{z}) characteristic for a slow rollover process pass the second low-pass filter (TP_{ω2}) unfiltered, and thereafter are compared with a second threshold value (S_{ω2}), when the integrated rotation rate signal (∫ωₓdt) has reached a first angle threshold value (αₗᵢₘᵢₜ), and
b) the safety device is triggered upon exceeding of the second threshold value (S_{ω2}) by the low-pass filtered rotation rate signal.

12. Method according to claim 11, wherein the second threshold value (S_{ω2}) corresponds to the value of a minimum rotation rate (ωₘᵢₙ)

13. Method according to claim 11, wherein
a) a third low-pass filtering of the rotation rate signals (ωₓ) is carried out by means of a third low-pass filter (TP_{ω3}) with a limit frequency (f_{ω3}), of which the value lies between the value of the limit frequency (f_{ω1}) of the first low-pass filter (TP_{ω1}) and the value of the limit frequency (f_{ω2}) of the second low-pass filter (TP_{ω2}), and thereafter the signal components of the rotation rate signals that pass through the third low-pass filter are compared with a third threshold value (S_{ω2}), when the integrated rotation rate signal (∫ωₓdt) has reached a second angle threshold value (S_{α2}), and
b) the safety device is triggered upon exceeding of the third threshold value (S_{ω3}) by the low-pass filtered rotation rate signal.

14. Method according to claim 13, wherein the third threshold value (S_{ω3}) lies between the value of the first threshold value (S_{ω1}) and the value of the second threshold value (S_{ω2}).

15. Method according to claim 2, wherein the lateral acceleration (a_{y}) detected by means of the acceleration sensor (B_{y}), after a low-pass filtering by means of at least one low-pass filter (TP_{y1}), is compared with a plausibility threshold (S_{y1}, S_{y2}), whereby a triggering is possible only when the value of the low-pass filtered acceleration signal exceeds this plausibility threshold (S_{y1}, S_{y2}).

16. Method according to claim 2, wherein the vertical acceleration (a_{z}) detected by means of the acceleration sensor (B_{z}), after a low-pass filtering by means of at least one low-pass filter (TP_{z1}, TP_{z2}), is compared with the acceleration value of 1G, whereby a triggering is possible only when the value of the low-pass filtered acceleration signal essentially deviates from this value.
